(19) United States
(12) Patent Application Publication
(10) Pub. No.: US 2003/0217182 A1
(43) Pub. Date: Nov. 20, 2003

(54) Interface architecture

(76) Inventors: Xiaodong Liu, Indianapolis, IN (US); Thomas Herbert Jones, Westfield, IN (US); Jeffery Lynn Taylor, Rushville, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/146,328

(22) Filed: May 15, 2002

(51) Int. Cl. G06F 15/16

(52) U.S. Cl. 709/249

(57) ABSTRACT

A universal interface module for use between heterogeneous networks for reserving processing power of a system processor includes a physical connection block having at least two ports for making a physical connection between networks. A gating device is coupled to the connection block and distributes packets of information of different formats to appropriate networks. A packet processing device is coupled to the gating device for adding and removing data and addressing information from the packets. An application demultiplexer is coupled to the packet processing device and distributes data and control signals to applications to be run on a system processor.

### FIELD OF THE INVENTION

The present invention generally relates to network communication systems and, more particularly, to a method and system which provides a physical layer interface to route data to an appropriate destination with limited involvement by a main system computer processor unit.

### BACKGROUND OF THE INVENTION

In many service provider communications networks, services and management functions are performed at a central office or other hub location. For example, in asynchronous transfer mode/asynchronous digital subscriber line (ATM/ADSL) networks, management and service functions are performed on equipment typically maintained at a central office, for example, switching equipment and multiplexing equipment. The ATM/ADSL networks also include equipment maintained at a customer's location, for example, customer premise equipment (CPE) and customer interface devices, such as telephones and computers. Other devices employed at the customer's location may include set-top boxes.

In a DSL environment, a set top box used for home audio/video instruments can have several possible interface types as the front-end application data input. These interfaces may include, for example, an ADSL/VDSL modem, HPNA (home phoneline network alliance) interface, or an Ethernet port. One configuration may include an ADSL modem port connected to service provider head-end equipment to receive application data content. Then, the primary DSL receiver (e.g., customer premise equipment (CPE)) for this front-end device could re-distribute the application data via an HPNA port to a secondary DSL receiver (e.g., a set-top box) for displaying the content.

Currently, on the integrated circuit (IC) market, a plurality of IC's is available corresponding to different interfaces and protocols for communication between and within networks. These IC's form part of a physical layer (PHY) for communication protocols. Such PHY interfaces may include, e.g., stand alone ADSL PHY, HPNA PHY or other physical layer ICs. These ICs will encapsulate Internet protocol (IP) packets according to different physical signals and deliver the IP packets over different type of networks.

Different network interfaces require different network controllers. These network controllers must be supported by the primary receiver device, such as set-top boxes. For a set-top box to support more than one interface type often requires a central office or other main network computer to do the majority of de-packetization and re-packetization to route the data from one type of network to another type of network, since it is currently very inefficient for applications to run on the set-top box. The de-packetization/re-packetization requires a lot of data manipulation from the main network processor, and therefore ties up needed resources.

Therefore, a need exists for a method and system, which provides a physical layer interface to route the data to appropriate destinations without the involvement of a main network processor. A further need exits for diverting processing activity away from the main network processor.

### SUMMARY OF THE INVENTION

A universal interface module for use between heterogeneous networks, for reserving processing power of a system processor, includes a physical connection block having at least two ports for making a physical connection between networks. A gating device is coupled to the connection block and distributes packets of information of different formats to appropriate networks. A packet processing device is coupled to the gating device for adding and removing data and addressing information from the packets. An application demultiplexer is coupled to the packet processing device and distributes data and control signals to applications to be run on a system processor.

A method for routing information packets between heterogeneous networks for reserving processing power of a system processor includes providing a universal interface module which physically connects at least two ports between different networks. Packets of information of different formats are gated and degated between appropriate networks. The packets are processed by adding and removing data and addressing information to/from the packets. The packet information is demultiplexed to distribute data and control signals to applications to be run on a system processor.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is an exemplary digital subscriber line (DSL) system architecture showing a broadband architecture employing a universal interface module in accordance with the present invention;

FIG. 2 is a block/flow diagram of an illustrative universal module in accordance with one embodiment of the present invention.

It should be understood that the drawings are for purposes of illustrating the concepts of the invention and are not necessarily the only possible configuration for illustrating the invention.

### DETAILED DESCRIPTION OF THE INVENTION

The present invention includes a method and system, which provides a physical layer (PHY) interface capable of handling inputs from a plurality of different types of networks. The present invention provides a universal broadband interface module to route data to an appropriate destination with limited involvement by a main system computer processor unit (CPU). The interface module includes a digital signal processor (DSP) based sub-system, which will perform medium access control (MAC) level gating, packet de-packetization and re-packetization mostly or completely independent from the system's main CPU(s). The type of network interface supported by the present invention can be versatile, and expandable for future broadband home consumer appliances. The interface may include, for example, asynchronous transfer mode (ATM) PHY or other type of head-end interface capabilities.

It is to be understood that the present invention is described in terms of an interface module configured for a plurality of PHY interfaces; however, the present invention is much broader and may include capability with any network, including cable, wireless, DSL or other networks, where the user needs to switch services between networks. In addition, the present invention is applicable to any system which delivers broadband services including data transmission over telephones, set top boxes, computer, satellite links, etc. The present invention is described in terms of a DSL network; however, the concepts of the present invention may be extended to cable, wireless or other network types using ATM technology.

It should be understood that the elements shown in the FIGS. may be implemented in various forms of hardware, software or combinations thereof. Preferably, these elements are implemented in hardware on one or more appropriately programmed general-purpose devices, which may include a processor, memory and input/output interfaces.

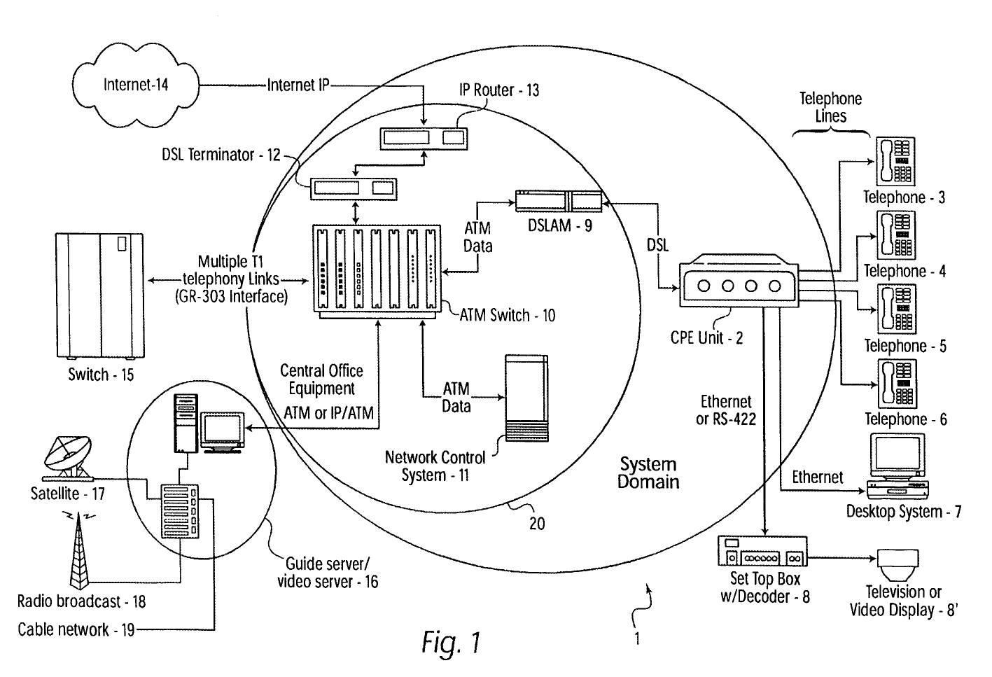

Referring now in specific detail to the drawings in which like reference numerals identify similar or identical elements throughout the several views, and initially to FIG. 1, a DSL system architecture 1 for integrating voice, data and video services is shown. System architecture 1 is presented as an exemplary DSL environment for employing the inventive method and system in accordance with the present invention.

The system domain 1 includes Central Office (CO) Equipment 20 and Customer Premise Equipment (CPE) 2. The component blocks within the system domain 1 and their respective interfaces are: customer premise equipment (CPE) 2, Digital Subscriber Line Access Multiplexer (DSLAM) 9, an ATM switch 10 and an internet protocol (IP) router 13 and ATM terminator 12. The ATM switch 10 is shown coupled to a program guide server/video server 16 to satellite 17, radio broadcast 18 or cable 19 networks. The ATM switch 10 is also coupled over the DSL terminator 12 and IP router 13 pair to receive Internet Protocol IP packet data from the Internet 14.

The current customer premise equipment (CPE) 2 includes a DSL modem unit 30 that interfaces with separate analog telephones 3-6 over a plain old telephone service (POTS), a 10Base-T Ethernet connection to a PC desktop system 7, and an Ethernet or RS-422 connection to a set-top box with a decoder 8 for connection to a television or video display 8′. Set top box 8 may include inputs from other networks as well. For example, inputs from a powerline network, an ATM network, a USB network or other networks may also be connected to set top box 8 in accordance with the present invention.

From the customer's analog end, the CPE device 2 accepts the analog input from each of the telephones 3-6, converts the analog input to digital data, and packages the data into ATM packets (Voice over ATM), with each connection having a unique virtual channel identifier/virtual path identifier (VPI/VCI). Known to skilled artisans, ATM is a connection-oriented protocol, and, as such, there is a connection identifier in every cell header, which explicitly associates a cell with a given virtual channel on a physical link. The connection identifier includes two sub-fields, the virtual channel identifier (VCI) and the virtual path identifier (VPI). Together these identifiers are used at multiplexing, demultiplexing and switching a cell through the network. VCIs and VPIs are not addresses, but are explicitly assigned at each segment link between ATM nodes of a connection when a connection is established, and remain for the duration of the connection. When using the VCI/VPI, the ATM layer can asynchronously interleave (multiplex) cells from multiple connections.

The Ethernet data is also encapsulated into ATM cells with a unique VPI/VCI. The ATM cell stream is sent to the DSL modem of the CPE unit 2 to be modulated and delivered to the DSLAM unit 9. The DSL signal is received and demodulated by the DSL modem 30 in the customer premise equipment 2 and delivered to VPI/VCI detection processing. The ATM cell data with VPI/VCI matching that of the end user's telephone is then extracted and converted to analog POTS to be delivered to the telephone. The ATM cell data with VPI/VCI matching that of the end user's Ethernet is extracted and delivered to an Ethernet transceiver for delivery to that port.

The Digital Subscriber Line Access Multiplexer (DSLAM) 9 demodulates data from multiple DSL modems and concentrates the data onto the ATM backbone network for connection to the rest of the network. DSLAM 9 provides back-haul services for package, cell, and/or circuit based applications through concentration of the DSL lines onto ATM outputs to the ATM switch 10.

The ATM switch 10 is the backbone of the ATM network. The ATM switch 10 performs various functions in the network, including cell transport, multiplexing and concentration, traffic control and ATM-layer management. Of particular interest in the system domain 1, the ATM switch 10 provides for the cell routing and buffering in connection with the DSLAM 9 and the Internet gateway (Internet Protocol IP router 13 and DSL or ATM terminator 12), and T1 circuit emulation support in connection with the multiple telephony links switch 15. The ATM switch 10 may be coupled to a program guide server/video server 16 to connect and interface with satellite, radio broadcast or cable networks. The ATM switch 10 is also coupled over the ATM terminator 12 and IP router 13 pair to receive Internet Protocol IP packet data from the Internet 14.

NCS 11 provides the termination point for the signaling that controls the setting up and tearing down of virtual circuits based on users access rights and requests. In addition, NCS 11 also provides functions for permitting a customer to control the content flow, may be controlled by a user through, for example, set top box 8, in much the same way as traditional VCR functionalities. NCS 11 also provides information on customer activity for billing purposes.

NCS 11 provides for address translation, demand assignment and call management functions and manages the DSL/ATM network including the origination and termination of phone calls and service requests and orders. NCS 11 is essentially the control entity communicating and translating control information between the class 5 PSTN switch 15 (using e.g., the GR-303 protocol) and the CPE 2. The network control system 11 is available for other functions such as downloading code to the CPE, and bandwidth and call management functions, as well as other service provisioning and setting up tasks.

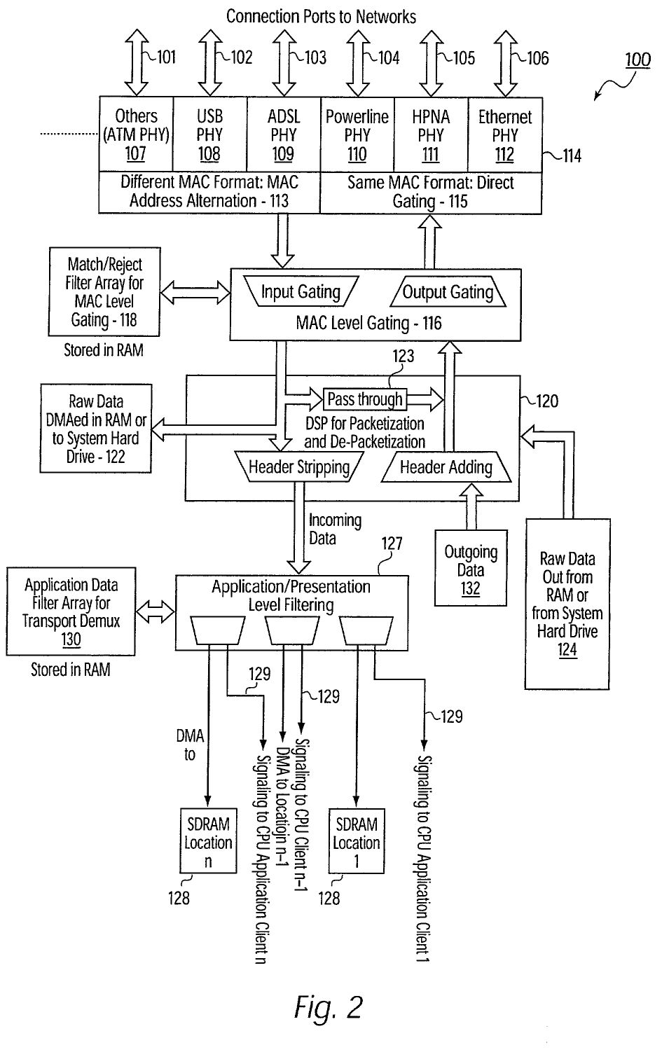

The interface between CPE 2 and set top box 8 may include, e.g., 1394 cable, Ethernet link, coax cable, wireless, etc. depending on the network/interface connected to. Module 100 (FIG. 2) may be implemented at the CPE 2 level, at the set top box 8 level or any other appropriate location in the network.

Referring to FIG. 2, a dedicated universal interface engine or universal interface module 100 is shown in accordance with one embodiment of the present invention. Module 100 permits data flow from one type of network to another. Module 100 preferably includes a digital signal processing (DSP) based subsystem which performs medium access control (MAC) level gating, packet de-packetization and re-packetization substantially or completely independent of a system's main CPU (e.g., NCS 11 in FIG. 1).

Module 100 may be implemented at the CPE 2 level or at the set top box 8 level. Module 100 is preferably implemented in set top box 8. Module 100 includes connections 101-106 to a head-end 1 or other network. Connections 101-106 provide two-way communication between module 100 and provider networks (e.g., connections 101-103) and module 100 and local networks (e.g., home networks, etc. on connection 104-106). Advantageously, connections 101-106 can receive information in different MAC formats. As a result, module 100 provides a versatile physical layer interface that may be employed for interfacing with a plurality of network PHY layers.

Connections 101-106 connect to correlated register blocks 107-112 corresponding to specific types of physical port PHY interfaces. These interfaces are illustratively depicted as an ATM PHY port (107), USB PHY port (108), an ADSL PHY port (109), a powerline PHY port (110) for a powerline home network, a home phoneline network alliance (HPNA) PHY port (111) and an Ethernet PHY port (112). These blocks are collectively referred to as a network interface PHY control block 114. For each PHY control block 114, there is a MAC address-gating block 116, which will transform MAC addresses from one type of network to another. Block 114 manages conversions of different MAC formats for both input and output operations between module 100 and provider side networks (e.g., head-end 1) through blocks 107-109 in block 113 and between module 100 and user-side networks (e.g., a home network) through blocks 110-112 in block 115.

Gating block 116 manages addressing/multiplexing content received and sent over connected networks. Input and output gating is performed at the MAC level. Gating block 116 works in conjunction with a MAC level filtering block 118, which filters the MAC address for any incoming packets from different type of networks and provides the proper MAC address to the outgoing packets to different type of networks. Once packets, e.g., ATM packets, are appropriately routed to the proper destinations, processing of the packet content is performed.

After the MAC level gating layer 116, packets are routed to an application data packet de-packetization and re-packetization block 120. For incoming packets, block 120 performs digital signal processing (DSP) to remove packet headers, and decipher data and control signals. For outgoing packets, headers are added with routing/address information to provide for packet delivery destinations. In block 122, before data enters the de-packetization and re-packetization block 120, there is an optional data path permitting a host backend system to store the raw data from the network to a system's random access memory (RAM) or hard drive memory location. Also, the stored raw data may be streamed out to a type of network by direct memory access (DMA) in block 124. This option is useful for hard drive based applications.

Block 122 includes a pass through 123, which permits the direct routing of packets of information through module 100 if the information in the header or data content of the packet is not to be used by module 100.

A presentation level transport demultiplexing block 127 delivers the correlated data coming from the different types of networks to different applications running on a network system's main CPU 11 (FIG. 1) or other processor(s) capable of running applications. By employing interrupt signaling 129, application/presentation level 127 directs data/control signals to and from memory locations 128 to initiate and/or maintain applications running on a system processor(s). A data filter array 130 may be employed to direct application data and control signals to appropriate applications for the transport demultiplexing functions of block 127. Outgoing data and control signals in block 132 from system CPU's or other processors are packetized and gated to appropriate networks.

By employing the interface engine 100 in accordance with the present invention, a system CPU is less burdened with packet and data management in a multi-network system. These management functions make a CPU inefficient particularly for systems with multi-network capable consumer products. In conventional systems, a large amount of CPU time and lot of software executed in the system's main CPU are needed to accomplish the data routing from one type of network to another.

Module 100 of the present invention advantageously redistributes multiplexing and demultiplexing tasks away from a system processor. This permits the system CPU or other processor to concentrate on other tasks such as video display, graphic rendering, web browsing, etc. In addition, by employing a universal broadband interface, a plurality of different types of networks can be supported by a device or network. Module 100 may be expandable for future broadband home consumer appliance. The interface may include ATM PHY or other type of head-end interface capabilities.

Having described preferred embodiments for broadband interface architecture (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. An interface module for interfacing at least two different networks to a system processor, comprising:
at least two ports, each making a connection to a separate one of at least two different networks for receiving incoming packets from and for sending outgoing packets to each separate network;
a gating device for converting to a proper format incoming packets received from and outgoing packets destined for each port;
a packet processing device for removing information from incoming packets received from, and for adding information to outgoing packets sent to the gating device; and
a demultiplexer for distributing incoming packets from the packet processor to the system processor and for distributing outgoing packets from the system processor to the packet processor.

2. The module as recited in claim 1, wherein the physical connection block supports a connection to at least one of asynchronous transfer mode, universal serial bus, digital subscriber line, powerline, home phoneline network alliance and Ethernet networks.

3. The module as recited in claim 1, wherein the gating device performs Medium Access Control (MAC) level gating.

4. The module as recited in claim 1, wherein the gating device includes a filter array for deciphering an appropriate network to receive packets of information.

5. The module as recited in claim 1, wherein the packet processing device includes a digital signal processor which packets and depackets information for transfer between networks.

6. The module as recited in claim 1, wherein the packet processing device includes a data path to and from a memory storage device for storing and retrieving raw data include in the packets.

7. The module as recited in claim 1, wherein the application demultiplexer distributes data and control signals to individual clients served by a network.

8. The module as recited in claim 1, wherein the module is a standalone interface between a system processor and a local network.

9. A method for routing information packets between networks for reserving processing power of a system processor, comprising the steps of:
providing an interface module for coupling at least two ports between different networks;
gating and degating packets of information of different formats between appropriate networks;
processing the packets of information by adding and removing one of data and addressing information to and from the packets respectively; and
demultiplexing the packets of information to distribute data and control signals to applications to be run on a system processor.

10. The method as recited in claim 9, wherein the universal interface module interfaces between at least one of asynchronous transfer mode, universal serial bus, digital subscriber line, powerline, home phoneline network alliance and Ethernet networks and another network.

11. The method as recited in claim 9, wherein the step of gating includes medium access control level gating.

12. The method as recited in claim 9, wherein the step of gating includes deciphering an appropriate network to receive packets of information by employing a filter array.

13. The method as recited in claim 9, wherein the step of processing includes employing a digital signal processor to packet and depacket information for transfer between networks.

14. The method as recited in claim 9, wherein the step of processing includes storing and retrieving raw data included in the packets by employing a memory storage device.

15. The method as recited in claim 9, wherein the step of demultiplexing includes distributing data and control signals to individual clients served by a network.
